(19) United States
(12) Patent Application Publication
(10) Pub. No.: US 2025/0111285 A1
(43) Pub. Date: Apr. 3, 2025

(54) Self-Supervised Learning for Temporal Counterfactual Estimation

(71) Applicant: Google LLC, Mountain View, CA (US)

(72) Inventors: Yan Liu, Santa Monica, CA (US); Chuizheng Meng, Los Angeles, CA (US); Yihe Dong, New York, NY (US); Sercan Omer Arik, San Francisco, CA (US); Tomas Pfister, Redwood City, CA (US)

(21) Appl. No.: 18/902,137

(22) Filed: Sep. 30, 2024

Related U.S. Application Data
(60) Provisional application No. 63/586,261, filed on Sep. 28, 2023.

(51) Int. Cl. G06N 20/00

(52) U.S. Cl. CPC G06N 20/00

(57) ABSTRACT

A machine-learned model includes an encoder having a feature block configured to embed input data into a plurality of features in an embedding space. The input data includes multiple components such as covariate, treatment, and output components. The encoder includes one or more encoding layers, each including a temporal attention block and a feature-wise attention block. The temporal attention block is configured to obtain the embedded input data and apply temporal causal attention along a time dimension in parallel for each feature of the plurality of features to generate temporal embeddings. The feature-wise attention block is configured to obtain the temporal embeddings and generate component representations such as a covariate representation, a treatment representation, and an output representation.

### RELATED APPLICATIONS

This application is based upon and claims the right of priority to U.S. Provisional Application No. 63/586,261, filed on Sep. 28, 2023, the disclosure of which is hereby incorporated by reference herein in its entirety for all purposes.

### FIELD

The present disclosure relates generally to machine learning systems for estimations of treatment outcomes over time while conditioning on an observed history. More particularly, the present disclosure relates to machine learning systems for generating predicted outcomes based on observed historical sequence data.

### BACKGROUND

Artificial intelligence systems can generate estimations of treatment outcomes over time while conditioning on an observed history. The accuracy of such estimations, however, has proven to be a fundamental challenge for decision making in various applications. While randomized controlled trials (RCTs) are standard for treatment outcome estimation, such trials can be too costly to cover enough samples or impractical to conduct. Therefore, utilizing available observed data (such as electronic health records (EHRs) and historical sales) for accurate treatment outcome estimation, has drawn increasing interest as a more feasible alternative.

Compared to static treatment outcome estimation, the time-varying or longitudinal setting is both more ubiquitous in real-world applications and more challenging. Both the complex dynamics and the long-range dependencies in time series data raise challenges. Another difficulty is the existence of time-dependent confounders. The inclusion of both past treatments and covariates can affect current treatments as well as outcomes. Estimators directly minimizing the empirical risk on observed data might thus contain biases due to the incapability of isolating the effect of past and current treatments.

### SUMMARY

Aspects and advantages of embodiments of the present disclosure will be set forth in part in the following description, or can be learned from the description, or can be learned through practice of the embodiments.

One example aspect of the present disclosure is directed to a system including one or more processors and one or more non-transitory computer-readable media that collectively store a machine-learned model including an encoder. The encoder includes a feature block configured to embed input data into a plurality of features in an embedding space. The input data includes multiple components. The encoder includes one or more encoding layers, each including a temporal attention block and a feature-wise attention block. The temporal attention block is configured to obtain the embedded input data and apply temporal causal attention along a time dimension in parallel for each feature of the plurality of features to generate temporal embeddings. The feature-wise attention block is configured to obtain the temporal embeddings and generate component representations of the input data, the component representations including a respective representation for each of the multiple components.

Another example aspect of the present disclosure is directed to a computer-implemented method to perform outcome estimation. The method includes operations performed by a computing system including obtaining historical data having covariate, treatment, and outcome components, obtaining a machine-learned model including an encoder, providing the historical data as one or more inputs to the machine-learned model, and pre-training the encoder using a self-supervised learning loss having component-wise losses including a respective loss for each of the multiple components of the input data.

Another example aspect of the present disclosure is directed to one or more non-transitory computer-readable media that collectively store a self-supervised counterfactual transformer including an encoder. The encoder includes a feature block configured to embed input data into a plurality of features in an embedding space, the input data including multiple components. The encoder includes one or more encoding layers, each encoding layer including a temporal attention block and a feature-wise attention block. The temporal attention block is configured to obtain the embedded input data and apply temporal causal attention along a time dimension in parallel for each feature of the plurality of features to generate temporal embeddings. The feature-wise attention block configured to obtain the temporal embeddings and generate component representations of the input data, the component representations including a respective representation for each of the multiple components.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1A-1C depict an example of a machine-learned system 100 according to example embodiments of the present disclosure.

FIG. 2 depicts a flowchart of a method for training one or more machine-learned models according to aspects of the present disclosure;

FIG. 3 is a block diagram of an example processing flow for using machine-learned model(s) to process input(s) to generate output(s);

FIG. 4 is a block diagram of an example implementation of an example machine-learned model configured to process sequences of information;

FIG. 5 is a block diagram of an example technique for populating an example input sequence;

FIG. 6 is a block diagram of an example model development platform that can facilitate creation, adaptation, and refinement of example machine-learned models;

FIG. 7 is a block diagram of an example training flow for training a machine-learned development model;

FIG. 8 is a block diagram of an inference system for operating one or more machine-learned model(s) to perform inference (e.g., for training, for deployment, etc.);

FIG. 9 depicts a block diagram of an example networked computing system that can perform aspects of example implementations of the present disclosure;

FIG. 10 illustrates one example arrangement of computing systems that can be used to implement the present disclosure;

FIG. 11 depicts a block diagram of an example computing device that performs according to example embodiments of the present disclosure; and

FIG. 12 depicts a block diagram of an example computing device that performs according to example embodiments of the present disclosure.

Reference numerals that are repeated across plural figures are intended to identify the same features in various implementations.

### DETAILED DESCRIPTION

### Overview

Generally, the present disclosure is directed to the estimation of counterfactual treatment outcomes over time from an observed history for decision-making in domains such as healthcare, e-commerce, and others. For example, the systems and methods disclosed herein provide an approach that integrates self-supervised learning for improved historical representation. A machine-learned model combines temporal and feature-wise attention, yielding improved performance in estimation accuracy and generalization to out-of-distribution data compared to existing approaches.

A self-supervised counterfactual transformer (SCOT) is described that utilizes self-supervised learning (SSL) to improve counterfactual outcome estimation over time. In example implementations, the SCOT adapts self-supervised learning with component-wise contrastive losses tailored for temporal observations to learn more expressive representations of a history for temporal counterfactual outcome estimation. The SCOT can include an encoder architecture that combines both temporal attention and feature-wise attention for better modeling of the complex temporal dependencies and feature interactions in observations. Empirical results show that the proposed framework can outperform existing baselines across both synthetic and real-world datasets in both estimation accuracy and generalization. In addition, the learned representations are balanced towards treatments and thus address the temporal confounding issue in an improved way.

The systems and methods disclosed herein can be utilized to generate accurate estimations of treatment outcomes over time conditioned on an observed history. By way of example, an output of the machine-learned system can include an estimation of a patient's personalized response including vital signs after applying one-step or multi-step healthcare treatments. As another example, an output can include an estimation of future sales after adjusting the price or other attribute of a certain item. The disclosed approach can accurately model sequential data, capturing the complex dynamics and the long-range dependencies in time series data. The disclosed approach can handle time-dependent confounders including past treatments and covariates that affect current treatments and outcomes.

In some implementations, a self-supervised counterfactual transformer (SCOT) is provided that is configured to learn representations of observed history sequences that are informative for counterfactual treatment outcome estimation. A representation encoder architecture and self-supervised training loss can be employed for accurately modeling observed historical data. A decoder is provided for non-autoregressive outcome prediction and improved accuracy and speed of multi-step estimation.

In some implementations, the SCOT includes an encoder that maps an entire history (e.g., historical data including observed history sequences) to representations for each feature. The feature-wise representations can be used (e.g., by average pooling) to generate representations of covariate, treatment, and outcome components. In some examples, a representation of all features for the representation of the entire observed history can also be generated.

In some implementations, the encoder can be trained in a self-supervised way using contrastive losses for individual component representations. In some examples, a contrastive loss for the overall representation (e.g., entire sequence) can be used as well. For example, individual contrastive losses can be generated for a covariate component representation, a treatment component representation, and an outcome component representation. An additional contrastive loss for the overall representation can be constructed for self-supervised training. The overall self-supervised learning loss can be based on the contrastive loss for the entire sequence and the component-wise contrastive losses.

In some implementations, the SCOT includes a predictor or predictor stage. The predictor can encode the observed history using the pretrained encoder. The predictor can encode the treatment applied before a selected treatment using a 1X1 convolution layer and encode the remaining treatment sequence with a 1D convolution layer. The concatenated encoding can be fed into a multi-layer perceptron network (LMP) to predict future outcomes. The predictor layers can be jointly trained. The pretrained encoder can be finetuned with the loss of factual outcome estimation weighted for each step.

The systems and methods of the present disclosure provide a number of technical effects and benefits. As one example, the systems and methods can include a machine-learned model that integrates self-supervised learning for improved historical representation. The model combines temporal and feature-wise attention to yield superior performance in estimation accuracy and generalization to out-of-distribution data compared to existing models, as validated by empirical results on both synthetic and real-world datasets. Previous approaches have focused on models trained with supervised outcome estimation on factual data to address challenges of modeling sequential data and time-dependent confounders. These approaches, however, focus on predicting future outcomes and neglect information in observed history, which may struggle with generalization across different domains. By combining self-supervised learning and an encoder with temporal and feature-wise attention, improved computing performance in estimation accuracy for counterfactual scenarios is seen.

As one example, the disclosed self-supervised learning approach achieves strong performance with the advantage of not relying on labeled data. Self-supervised learning applied to counterfactual outcome estimation over time proves an effective way of learning informative representations. Moreover, by incorporating temporal and feature-wise attention with self-supervised learning, the introduction of bias associated with supervised learning approaches can be avoided. The inclusion of temporal and feature-wise attention with self-supervised learning can provide a more efficient computing system by reducing model runtimes and reducing the usage of computing resources such as memory and processor capacity.

Existing approaches that rely on fully supervised loss of future outcomes to learn representations of history suffer from limitations. For example, the learned representations focus on predicting future outcomes in a biased way and thus neglect discriminative information about past and future covariates. Additionally, these techniques only capture the dependencies of outcomes on observed feature distributions while having difficulty generalizing to different domains.

In some implementations, the systems and methods of the present disclosure provided a self-supervised learning approach that is adapted together with component-wise contrastive losses tailored for temporal observations to learn more expressive representations of the history for temporal counterfactual outcome estimation. An encoder architecture combining both temporal attention and feature-wise attention provides better modeling of the complex temporal dependencies and feature interactions in observations. Empirical results show that the disclosed framework can outperform existing baselines across both synthetic and real-world datasets in both estimation accuracy and generalization. In addition, the learned representations are balanced towards treatments and thus address the temporal confounding issue.

The disclosed approach can be applied in non-cold-start settings, cold-start settings, and few-shot settings. In one example of a non-cold-start setting, a self-supervised counterfactual transformer is shown to outperform baselines and to have an average improvement over other baselines. In one example of a cold-start setting, a self-supervised counterfactual transformer demonstrates state-of-the-art performance in most horizons after fine-tuning. The estimation errors decrease compared to best performing baselines. In one example of a few-shot setting, a self-supervised counterfactual transformer demonstrates state-of-the-art performance in all outcome estimation horizons across datasets. The estimation errors decrease compared to best performing baselines.

### Example Model Arrangements

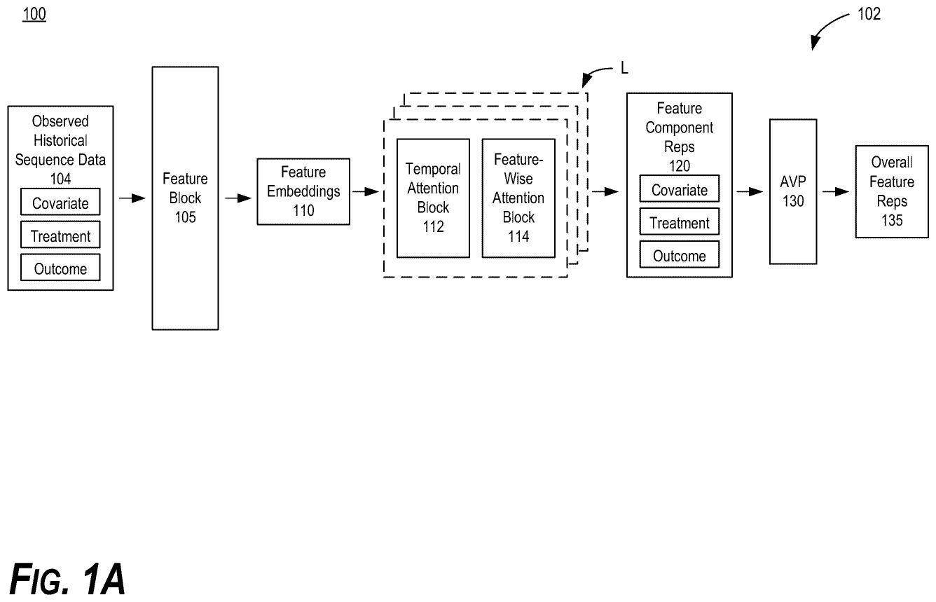

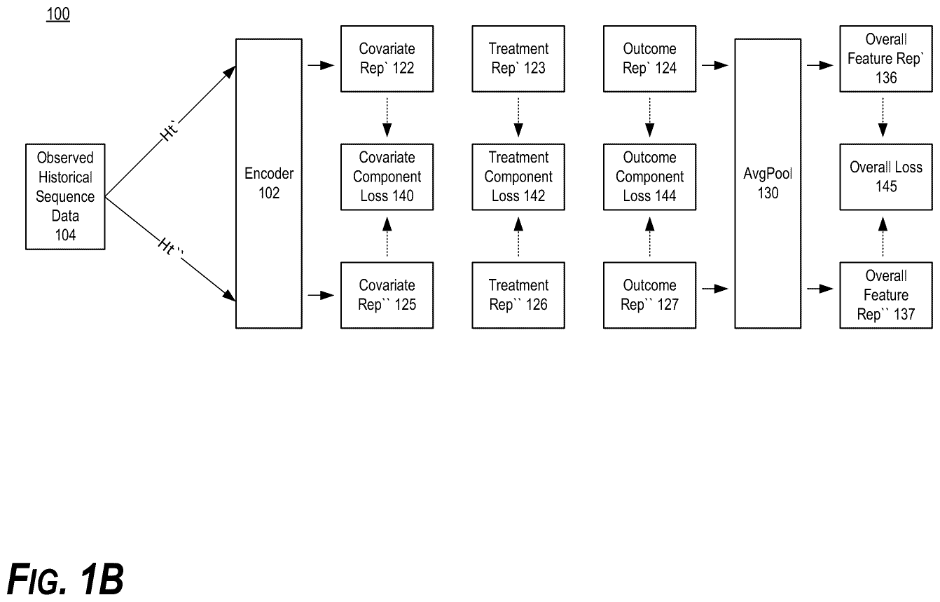

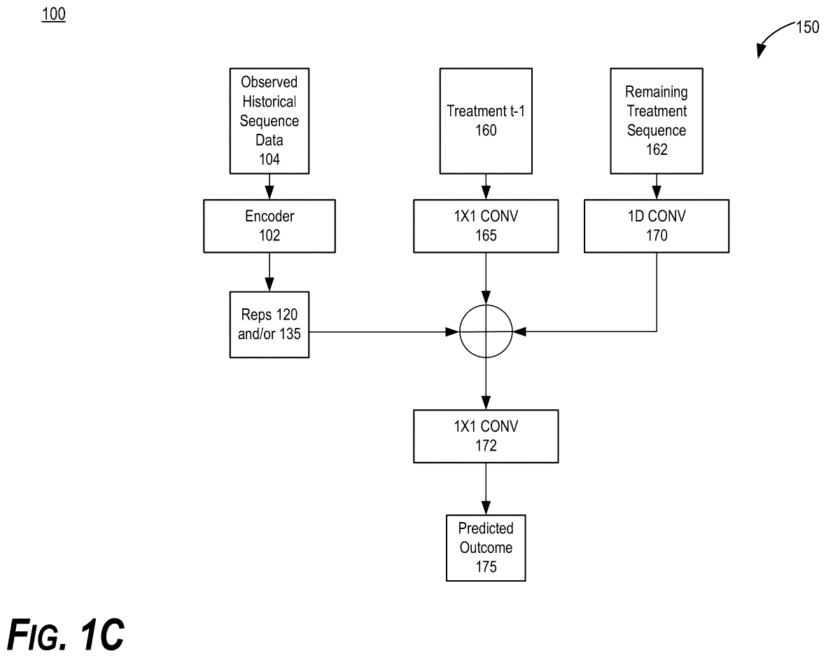

FIGS. 1A-1C depict an example of a machine-learned system 100 according to example embodiments of the present disclosure. In some implementations as shown in FIG. 1A, the system 100 includes an encoder 102 that is trained to receive a set of input data (e.g., observed historical sequence data 104) descriptive of covariates, treatments, and outcomes, and as a result of receipt of the input data, provide output data that is descriptive of feature component representations 120 of the historical data and/or an overall feature representation 126 of the entire sequence of the historical data. The output data from the encoder can be received as an input by a decoder 152 of the system as shown in FIG. 1C. The decoder 152 is trained to receive the feature representations and generate output data that is descriptive of future outcomes. In example embodiments, machine-learned system can be implemented as a self-supervised counterfactual transformer (SCOT) system 100.

In particular, encoder 102 of system 100 includes a feature block 105 that is configured to receive the set of input data such as observed historical sequence data 104 and generate a set of feature embeddings 110. The set of input data can include observed historical sequence data having covariate, treatment, and outcome components. The sequence data can include a sequence of historical data points. Each data point can include a covariate, treatment, and outcome component. Feature block 105 is configured to generate feature embeddings by embedding the input data into an embedding space.

In some implementations, the feature block includes an input feature projector and a feature positional encoder. The input feature projector is configured to receive the input data including covariate, treatment, and outcome components, and map it to an embedding space, for example, using a linear transformation. The input feature projector can map the input data to the embedding space using time-varying variables in history for the covariate, treatment, and outcome components. The feature positional encoder can enhance the input embedding with a positional encoding along the feature dimension. In one example, the system groups the features into covariates, treatments, and outcomes and forms a hierarchical structure with two levels. The structure is modeled with a learnable tree positional encoding. After obtaining stacked feature positional embeddings of time-varying and static features, the feature positional encoder broadcasts them to the shapes of the time-varying and static input feature projections, respectively. The embedded input is then the sum of input feature projection and feature positional encoding.

The encoder includes one or more attention layers L, each including a temporal attention block 112 and a feature-wise attention block 114. The temporal attention block captures the temporal dependencies within each feature. The temporal block can be constructed based on the self-attention part of a general transformer decoder, where a multihead attention module with temporal causal attention is followed by a pointwise feedforward module, and each module has residual connections with layer normalization. Relative positional encoding along the time axis can be used.

The temporal attention block in a particular layer receives the feature embedding from the previous layer and generates temporal embeddings. The temporal attention block can reshape the feature embedding from the previous layer into dₛ sequences having lengths of t, and pass them through the block in parallel. Static feature embeddings can be passed through the pointwise feedforward module only in examples.

The feature-wise attention block 114 models interactions among different features. In some implementations, the feature-wise attention block can be constructed using the architecture of a general transformer encoder, replacing the positional encoding with the feature positional encoding. The block in a particular layer receives the temporal embeddings from the temporal attention block and generates feature component representations 120 of the input data. The block can receive a temporal embedding from the temporal attention block and reshape it into t sequences, each with a length dₛ. The component representations generated by the feature-wise attention block can include propagated embeddings of time-varying features.

The feature component representations can be provided to average pooling block 125. Average pooling of the feature-wise representations from corresponding features can be used to generate the representations of the covariate, treatment, and outcome components, and all features for the representation 126 of the entire observed history.

The embeddings of time-varying features from the final layer can be re-organized to stepwise representations, and each stepwise representation can be further aggregated to feature component representations 120. When the encoder satisfies temporal causality, the representations can be seen as a sequence of representations for the observed history truncated at each time step.

When the encoder is fed with factual data in training stages, an advantage of encoders satisfying temporal causality is that the outcomes can be estimated and an evaluation can be performed of the factual estimation losses in every time step of the input sequence at a single forward pass. When evaluating counterfactual data, the encoder only needs to keep a representation of the entire observed history, conditioning on which the predictor rolls out outcome estimations given counterfactual treatments.

In contrast, feeding the entire history in one pass for training is error-prone for architectures and can violate the temporal causality (e.g., transformers with fully temporal attention or frequency-based methods), since it leaks information of future steps into the representations in previous steps. Predictors trained with such representations converge quickly to a trivial model that simply copies future steps as estimations. When evaluating counterfactual data where future counterfactual outcomes are no longer available in input, the performance degenerates. As a result, the observed sequence has to be explicitly unrolled to t truncated sequences and t forward passes run to get the representations and factual errors in every step when training non-temporally-causal models. This leads to a T increase in training time when the batch size remains unchanged due to hardware restrictions, where T is the maximum length of sequences in training data.

FIG. 1B is a block diagram illustrating self-supervised learning of the history representations. The encoder 102 can be trained to learn representations of the observed historical sequence data with a self-supervised learning framework. Encoder 102 receives augmented historical data H̅′ₜ and H̅″ₜ. In an example, the encoder includes a momentum encoder and a 2-layer MLP as the prediction head. Random augmentations can be applied, including scaling, shifting and jittering on each sample in the input batch to generate a positive sample pair H̅′ₜ and H̅″ₜ. Their representations can be encoded. The sample H̅′ₜ is encoded to covariate representation 122, treatment representation 123, and outcome representation 124. The sample H̅″ₜ is encoded to covariate representation 125, treatment representation 126, and outcome representation 127. Average pooling block 130 generates overall feature representation 136 and overall feature representation 137.

A contrastive loss can be adopted as the training loss. In addition to the overall contrastive loss 145 of the overall representations, the training can be enhanced with contrastive losses on each subset of features: covariate, treatment, and outcome. Contrastive losses are constructed for the component representations. Covariate component loss 140, treatment component loss 142, and outcome component loss 144 are constructed from the respective component representations.

FIG. 1C is a block diagram of a decoder 150 of the SCOT in an example implementation. In some implementations, the decoder includes a predictor or predictor stage. The decoder encodes the observed historical sequence data 104 into feature component representations 120 and/or overall feature representations 135 using the pretrained encoder 102. The decoder encodes the treatment 160 applied before a selected treatment using a 1×1 convolution layer 165 and encodes the remaining treatment sequence 162 with a 1D convolution layer 170. The concatenated encoding is fed into a multi-layer perceptron network (LMP) 175 to predict a future outcome 175. The predictor layers can be jointly trained. The pretrained encoder can be finetuned with the loss of factual outcome estimation weighted for each step.

In example embodiments, the problem formulation can be seen as a task for estimating the outcomes of subjects with observed history after being applied a sequence of treatments from observational data. An available observed dataset can formalized as

$${\{ {\{ {x}_{t}^{( i )} , {a}_{t}^{( i )} , {y}_{t}^{( i )} \}}_{t = 1}^{T} , {v}^{( i )} \}}_{i = 1}^{N}$$

of N independently sampled subjects, where T⁽ⁱ⁾∈ [symbol] denotes the length of the observed history of subject i, and xₜ⁽ⁱ⁾∈ [symbol] ^{d}^{_{X}}, aₜ⁽ⁱ⁾∈ [symbol] ^{d}^{_{A}}, yₜ⁽ⁱ⁾∈ [symbol] ^{d}^{_{Y}} stand for the observed vector of covariates/treatments/outcomes at time t of subject i. v⁽ⁱ⁾∈ [symbol] ^{d}^{_{V}} contains all static features of subject i. The subject index I is omitted in the following text for simplification.

Following the potential outcomes extended to time-varying treatments and outcomes, the target can be to estimate E(y_{t+τ}[a_{t:t+τ-1}]|H̅ₜ) for τ≥1, where H̅ₜ=(X̅ₜ, Āₜ₋₁, Y̅ₜ, V) represents the observed history and ā_{t:t+τ-1}=(aₜ, aₜ₊₁ . . . , a_{t+τ-1}) stands for the sequence of the applied treatments in the future r discrete time steps.

To ensure the identifiability of treatment effect from observational data, standard assumptions can be taken in an example embodiment.

Assumption 1: Consistency. The potential outcome of any treatment at is always the same as the factual outcome when a subject is given the treatment aₜ:yₜ₊₁[aₜ]=yₜ₊₁.

Assumption 2: Positivity. If P(Āₜ₋₁, =āₜ₋₁, X̅ₜ=x̅ₜ)≠0, then P(Aₜ=aₜ|Āₜ₋₁, =āₜ₋₁, X̅ₜ=x̅ₜ)>0 for any āₜ.

Assumption 3: Sequential strong ignorability. Yₜ₊₁[aₜ]⊥⊥At Aₜ|Āₜ₋₁, X̅ₜ, ∀aₜ, t.

By way of example, a detailed design of a self-supervised counterfactual transformer (SCOT) is described. An example target is to learn representations of observed history sequences that are informative for counterfactual treatment outcome estimation, which is achieved by tailoring both the representation encoder architecture and the self-supervised training loss. On top of the representation learning, a simple yet effective decoder for non-autoregressive outcome prediction is used and improvements to both the accuracy and the speed of multi-step estimation is observed.

With reference to FIG. 1A, a given sequence of an observed history H̅ₜ∈ [symbol] ^{t×d}^{ᵢₙₚᵤₜ} can be concatenated from (X̅ₜ, Āₜ₋₁, Y̅ₜ). Static variables V can be omitted for simplicity. With dᵢₙₚᵤₜ=(d_{X}+d_{A}+d_{Y}), the encoder 102 can map the entire history to representations {zₜⁱ∈ [symbol] ^{d}^{_{model}}}ᵢ₌₁^{d}^{ᵢₙₚᵤₜ} for each feature fᵢ. Average pooling 130 of feature-wise representations from corresponding features can be used to obtain the overall feature representations 135 of covariate/treatment/outcome components, and all features for the representation of the entire observed history. The set of covariate/treatment/outcome variables can be denoted F_{X}, F_{A}, F_{Y}. With these denotations, Equations 1a and 1b can be defined.

$$Equation 1 a$$

$${z}_{t}^{X} = avg ( {\{ {z}_{t}^{i} \}}_{fi ∈ {F}_{X}} ) , {z}_{t}^{( A )} = avg ( {\{ {z}_{t}^{i} \}}_{{f}_{i} ∈ {F}_{A}} ) , {z}_{t}^{Y} avg ( {\{ {z}_{t}^{i} \}}_{{f}_{i} ∈ {F}_{Y}} )$$

$${z}_{t} = avg ( {\{ {z}_{t}^{i} \}}_{i = 1}^{{d}_{input}} ) \qquad Equation 1 b$$

Encoder 102 can be pretrained in a self-supervised way and contrastive losses [symbol] _{SSL}^{X}, [symbol] _{SSL}^{A}, [symbol] _{SSL}^{Y}, [symbol] _{SSL}^{H} can be constructed for the component representations Zᵢ^{X}, Zₜ^{A}, Zₜ^{Y} and the overall representation Zₜ respectively.

The overall self-supervised loss can be defined as set forth in Equation 2.

$${ℒ}_{S S L} = {ℒ}_{S S L}^{H} + ( {ℒ}_{S S L}^{X} + {ℒ}_{S S L}^{A} + {ℒ}_{S S L}^{Y} ) / 3 \qquad Equation 2$$

FIG. 1C depicts the architecture of the predictor 150. In the prediction stage, the observed history H̅ₜ can be encoded with the pretrained encoder 102. The treatment a_{t′-1} can be applied right before time t′=t+1, . . . , t+τ−1 with a 1×1 convolution layer 165 and the remaining treatment sequence (aₜ, aₜ₊₁, . . . , a_{t′-2}) 162 can be applied with a 1D convolution layer 170. Then, the concatenated encoding is fed into a multi-layer perceptron network (MLP) including a 1×1 convolution layer 172 to predict future outcomes (ŷₜ₊₁, ŷₜ₊₂, . . . , ŷ_{t+τ}) 175. The predict layers can be jointly trained and the pretrained encoder can be finetuned with the L₂ loss of factual outcome estimation weighted for each step as shown in Equation 3.

$${ℒ}_{est} = {\sum }_{i = 1}^{τ} {w}_{i} {‖ {\hat{y}}_{t + i} - {y}_{t + i} ‖}_{2}^{2} \qquad Equation 3$$

In Equation 3, wᵢs are hyperparameters satisfying Σᵢ₌₁^{τ} wᵢ=1.

FIG. 1A demonstrates an example embodiment of the encoder architecture 102. First, each scalar value across all time steps and features in the given history H̅ₜ are embedded into a d_{model}-dim vector using feature block 105 and the positional encoding along the feature dimension is added as the input of the L encoding layers. Each layer contains 2 attention blocks alternating between a temporal attention block 112 and feature-wise attention block 114. The propagated embeddings are grouped together and aggregated according to Equation 1a and Equation 1b.

The input feature projection can be defined by denoting the concatenation of time-varying variables (X̅ₜ, Āₜ₋₁, Y̅ₜ) in history as S̅ₜ∈ [symbol] ^{t×d}^{ₛ}, d_{S}=d_{X}+d_{A}+d_{Y}, and the static variables V∈ [symbol] ^{d}^{ᵥ}. A linear transformation fᵢₙₚᵤₜ: [symbol] → [symbol] ^{d}^{_{model}} can be adopted to map S̅ₜ and V to the embedding space as E^{S}∈ [symbol] ^{t×d}^{ₛ}^{×d}^{_{model}} and E^{V}∈ [symbol] ^{d}^{ᵥ}^{×d}^{_{model}}, respectively. In the linear transformation, E^{S} is defined as in Equation 4 and E^{V} is defined as in Equation 5.

$${E}^{S} [ i , j ] = {f}_{input} ( {\overline{S}}_{t} [ i , j ] ) , 1 \leq i \leq t , 1 \leq j \leq {d}_{s} \qquad Equation 4$$

$${E}^{V} [ j ] = {f}_{input} ( V [ i ] ) , 1 \leq j \leq {d}_{V} \qquad Equation 5$$

For feature positional encoding, a shared feature projection function among all features may not be sufficient to encode the feature-specific information since the same scalar value represents different semantics in different features. Meanwhile, feature-specific information can be needed for modeling the interactions among features. Therefore, the feature input embedding can be enhanced in example embodiments with a positional encoding along the feature dimension. Since the features can be grouped into covariates/treatments/outcomes and form a hierarchical structure with two levels, it can be modeled with a learnable tree positional encoding. The lists of covariate/treatment/outcome/static features can be denoted as F_{X}, F_{A}, F_{Y}, F_{V}. For the i-th feature fᵢ^{F} in a certain feature list F∈{F_{X}, F_{A}, F_{Y}, F_{V}}, its positional encoding is as set forth in Equation 6.

$${E}_{fea \_ pos} ( {f}_{i}^{F} ) = {E}_{fea} \cdot Concat ( {e}_{F} , {e}_{i} ) \qquad Equation 6$$

In Equation 6: e_{F}=(1,0,0,0) if F is F_{X}; e_{F}=(0,1,0,0) if F is F_{A}, e_{F}=(0, 0, 1, 0) if F is F_{Y}; and e_{F}=(0, 0, 0, 1) if F is F_{V}. eᵢ∈ [symbol] ^{max(d}^{_{X}}^{, d}^{_{A}}^{, d}^{_{Y}}^{, d}^{_{V}}⁾ is a one-shot vector with only eᵢ[i]=1·E_{fea}∈ [symbol] ^{d}^{_{model}}^{×(4+max(d}^{_{X}}^{, d}^{_{A}}^{, d}^{_{Y}}^{, d}^{_{V}}⁾⁾ are learnable tree embedding weights. After obtaining the stacked feature positional embeddings E_{fea_pos}^{S}∈ [symbol] ^{d}^{ₛ}^{×d}^{_{model}}, E_{fea_pos}^{V}∈ [symbol] ^{d}^{_{V}}^{×d}^{_{model}} of time-varying and static features, they can be broadcasted to the shape of E^{S} and E^{V}, respectively. The embedded input is then the sum of input feature projection and feature positional encoding as set forth in Equation 7 and Equation 8.

$${Z}^{S , ( 0 )} = {E}^{S} + Broa dcast ( {E}_{fea \_ pos}^{S} ) \qquad Equation 7$$

$${Z}^{V , ( 0 )} = {E}^{V} + Broa dcast ( {E}_{fea \_ pos}^{V} ) \qquad Equation 8$$

The temporal attention block 112 can capture the temporal dependencies within each feature. The block can be constructed based on the self-attention part in a standard transformer decoder, where a multihead attention module with temporal causal attention is followed by a pointwise feedforward module, and each module has residual connections with layer normalization. Considering the importance of relative time interval in modeling treatment effects, the relative positional encoding along the time axis can be adopted

The temporal attention block 112 in the l-th layer receives Z^{S,(l-1)} from the previous layer, reshapes it to sequences d_{S} with lengths t, and passes them through the block in parallel. The output Zₜₘₚ^{S,(l)} has the same shape as Z^{S,(l-1)}. Since Z^{V,(l-1)} is static, it is only passed through the pointwise feedforward module to get Zₜₘₚ^{V,(l)}.

The feature-wise attention block 114 models interactions among different features. The architecture of the standard transformer encoder can be reused but the positional encoding can be replaced with the feature positional encoding earlier described. The block in the l-th layer receives Zₜₘₚ^{S,(l)} from the temporal attention block and reshapes it to t sequences, each with a length d_{S}. Zₜₘₚ^{(V,(l)} can be broadcasted and concatenated with each sequence along the feature dimension to enable the attention among both time-varying and static features. The concatenated t sequences that attention are applied to are defined as set forth in Equation 9.

$${Z}_{tmp}^{SV , ( l )} = Concat ( {Z}_{tmp}^{S , ( l )} , Broadcast ( {Z}_{tmp}^{V , ( l )} ) ) ∈ {ℝ}^{t \times ( {d}_{S} + {d}_{V} ) \times {d}_{model}} \qquad Equation 9$$

Full attention among all features can be applied to the concatenated sequences to get Z^{SV,(l)} with the same shape as Zₜₘₚ^{SV,(l)}. The propagated embeddings of time-varying features can be sliced as shown in Equation 10.

$${Z}^{S , ( l )} = {Z}^{SV , ( l )} [ : , : {d}_{s} , : ] ∈ {ℝ}^{t \times {d}_{S} \times {d}_{model}} \qquad Equation 10$$

To keep Z^{V,(l)} static after feature-wise attention, Z^{V,(l)} can be propagated with full attention among static features only. The updated embeddings of static features Z_{V,(l)}∈ [symbol] ^{d}^{_{V}}^{×d}^{_{model}} has the same shape as Zₜₘₚ^{V,(l)}.

There are several benefits of satisfying temporal causality. The embeddings of time-varying features Z^{S,(L)}∈ [symbol] ^{t×(d}^{_{X}}^{+d}^{_{A}}^{+d}^{_{Y}}^{)×d}^{_{model}} from the final layer is re-organized to stepwise representations (Z₁, Z₂, . . . , Zₜ). Each (Zₜ, ={zₜⁱ, ∈ [symbol] ^{d}^{_{model}}}ᵢ₌₁^{d}^{_{X}}^{+d}^{_{A}}^{+d}^{_{Y}} is further aggregated to Zₜ^{X}, Zₜ^{A}, Zₜ^{Y}, Zₜ, in Equation 1. When the encoder satisfies the temporal causality (i.e., Zₜ, only depends on H̅ₜ,), they can be seen as a sequence of representation for the observed history H̅₁, H̅₂, . . . , H̅ₜ truncated at each time step.

When the encoder is fed with factual data in training stages, a major advantage of encoders satisfying temporal causality is that the outcomes can be estimated and the factual estimation losses in every time step of the input sequence at a single forward pass can be evaluated. In evaluating counterfactual data, the encoder only needs to keep Zₜ representing the entire observed history, conditioning on which the predictor rolls out outcome estimations given counterfactual treatments.

In contrast, feeding the entire history in one pass for training can be error-prone for architectures and can violate the temporal causality (e.g. transformers with fully temporal attention or frequency-based methods), since it leaks information of future steps into the representations in previous steps. Predictors trained with such representations converge quickly to a trivial model that simply copies future steps as estimations. When evaluating counterfactual data where future counterfactual outcomes are no longer available in input, the performance can degenerate. As a result, the observed sequence can be explicitly unrolled to t truncated sequences and run t forward passes to get the representations and factual errors in every step when training non-temporally-causal models. This can lead to an ×T increase in training time when the batch size remains unchanged due to hardware restrictions, where T is the maximum length of sequences in training data.

In an example implementation, the encoder 102 can be trained to learn representations of the history with a self-supervised learning framework including a modification of a self-supervised learning vision transformer that achieves state of the art performance in self-supervised vision transformer training. Following a self-supervised learning vision transformer framework, an encoder f_{enc} can be provided as a momentum encoder with the same architecture and initial weights f_{enc}^{mo}, and a 2-layer MLP as the prediction head f_{pred_head}: [symbol] ^{d}^{_{model}}→ [symbol] ^{d}^{_{mode}}. Random augmentations can be applied including scaling, shifting, and jittering on each sample in the input batch {H̅ₜ⁽ⁱ⁾}ᵢ₌₁^{B}, where B is the batch size. The positive sample pair {H̅ₜ⁽ⁱ⁾}ᵢ₌₁^{B}, {H̅″ₜ⁽ⁱ⁾}ᵢ₌₁^{B} can be generated. Their representations can be encoded as set forth in Equations 11a, 11b, 11c, and 11d.

$${Z}_{t}^{′ X ( i )} , {Z}_{t}^{′ A ( i )} , {Z}_{t}^{′ Y ( i )} , {Z}_{t}^{′ ( i )} = {f}_{enc} ( {\overline{H}}_{t}^{′ ( i )} ) , \qquad Equation 11 a$$

$${Z}_{t}^{″ X ( i )} , {Z}_{t}^{″ A ( i )} , {Z}_{t}^{″ Y ( i )} , {Z}_{t}^{″ ( i )} = {f}_{enc} ( {\overline{H}}_{t}^{″ ( i )} ) , \qquad Equation 11 b$$

$${Z}_{t}^{′ X , mo ( i )} , {Z}_{t}^{′ A , mo ( i )} , {Z}_{t}^{′ Y , mo ( i )} , {Z}_{t}^{′ mo ( i )} = {f}_{enc}^{mo} ( {\overline{H}}_{t}^{′ ( i )} ) , \qquad Equation 11 c$$

$${Z}_{t}^{″ X , mo ( i )} , {Z}_{t}^{″ A , mo ( i )} , {Z}_{t}^{″ Y , mo ( i )} , {Z}_{t}^{″ mo ( i )} = {f}_{enc}^{mo} ( {\overline{H}}_{t}^{″ ( i )} ) , \qquad Equation 11 d$$

The standard self-supervised learning vision transformer framework method can adopt a contrastive loss as the training loss as set forth in Equation 12.

$${ℒ}_{S S L}^{H} = {L}_{I n f o N C E} ( {\{ {f}_{pred \_ head} ( {z}_{t}^{′ ( i )} ) \}}_{i = 1}^{B} , {\{ {z}_{t}^{″ mo ( i )} \}}_{i = 1}^{B} + {L}_{I n f o N C E} ( {\{ {f}_{pred \_ head} ( {z}_{t}^{″ ( i )} ) \}}_{i = 1}^{B} , {\{ {z}_{t}^{′ mo ( i )} \}}_{i = 1}^{B} ) \qquad Equation 12$$

Equation 13 defines [symbol] _{InfoNCE}.

$$Equation 13$$

$${ℒ}_{I n f o N C E} ( {\{ {q}^{i} \}}_{i = {1}^{′}}^{B} {\{ {k}^{( i )} \}}_{i = 1}^{B} ) = - \frac{1}{B} {\sum }_{i = 1}^{B} log \frac{exp ( cos 〈 {q}^{( i )} , {k}^{( i )} 〉 )}{{\sum }_{j = 1}^{B} exp ( cos 〈 {q}^{( i )} , {k}^{( j )} 〉 )}$$

In addition to the contrastive loss of the overall representations, the training can be enhanced with contrastive losses on each subset of features: covariate/treatment/outcome, as set forth in Equation 14 and Equation 15.

$${L}_{S S L}^{( \cdot )} = {L}_{I n f o N C E} ( {\{ {f}_{pred \_ head} ( {z}_{t}^{′ ( \cdot ) ( i )} ) \}}_{i = 1}^{B} , {\{ {z}_{t}^{″ ( \cdot ) , mo ( i )} \}}_{i = 1}^{B} ) \qquad Equation 14$$

$$+ {L}_{I n f o N C E} ( {\{ {f}_{pred \_ head} ( {z}_{t}^{″ ( \cdot ) ( i )} ) \}}_{i = 1}^{B} , {\{ {z}_{t}^{′ mo ( i )} \}}_{i = 1}^{B} ) \qquad Equation 15$$

In Equations 14 and 15, (⋅) is X, A, Y.

### Example Methods

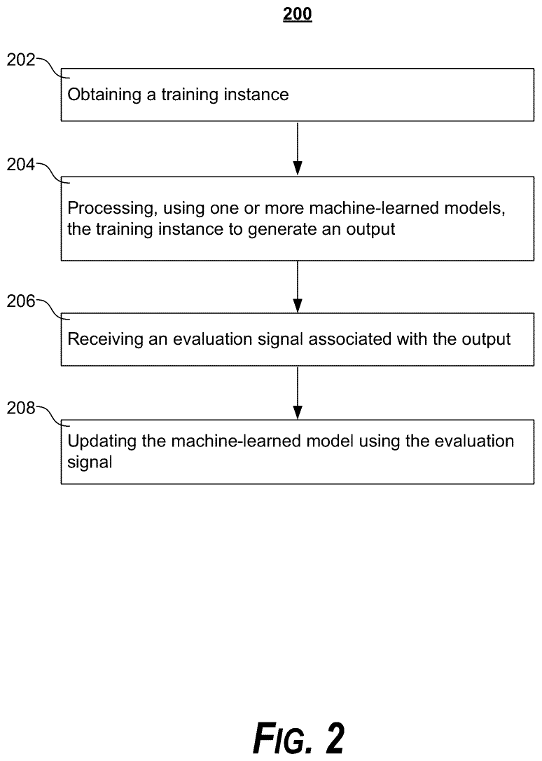

FIG. 2 depicts a flowchart of a method 200 for training one or more machine-learned models according to aspects of the present disclosure. For instance, an example machine-learned model can include a self-supervised counterfactual transformer.

One or more portion(s) of example method 200 can be implemented by a computing system that includes one or more computing devices such as, for example, computing systems described with reference to the other figures. Each respective portion of example method 200 can be performed by any (or any combination) of one or more computing devices. Moreover, one or more portion(s) of example method 200 can be implemented on the hardware components of the device(s) described herein, for example, to train one or more systems or models. FIG. 2 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 2 is described with reference to elements/terms described with respect to other systems and figures for exemplary illustrated purposes and is not meant to be limiting. One or more portions of example method 200 can be performed additionally, or alternatively, by other systems.

At 202, example method 200 can include obtaining a training instance. A set of training data can include a plurality of training instances divided between multiple datasets (e.g., a training dataset, a validation dataset, or testing dataset). A training instance can be labeled or unlabeled. Although referred to in example method 200 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 204, example method 200 can include processing, using one or more machine-learned models, the training instance to generate an output. The output can be directly obtained from the one or more machine-learned models or can be a downstream result of a chain of processing operations that includes an output of the one or more machine-learned models.

At 206, example method 200 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 208, example method 200 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 200 can include implementing a number of generalization techniques (e.g., weight decays, dropouts, etc.) to improve the generalization capability of the models being trained.

In some implementations, example method 200 can be implemented for training a machine-learned model from an initialized state to a fully trained state (e.g., when the model exhibits a desired performance profile, such as based on accuracy, precision, recall, etc.).

In some implementations, example method 200 can be implemented for particular stages of a training procedure. For instance, in some implementations, example method 200 can be implemented for pre-training a machine-learned model. Pre-training can include, for instance, large-scale training over potentially noisy data to achieve a broad base of performance levels across a variety of tasks/data types. In some implementations, example method 200 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

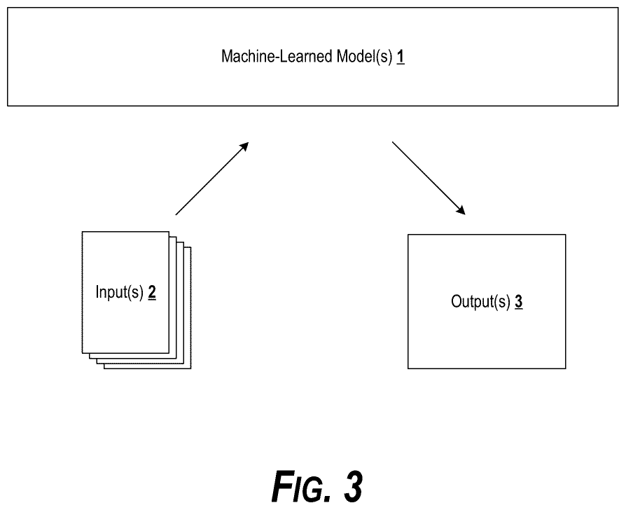

FIG. 3 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

### Example Machine-Learned Sequence Processing Models

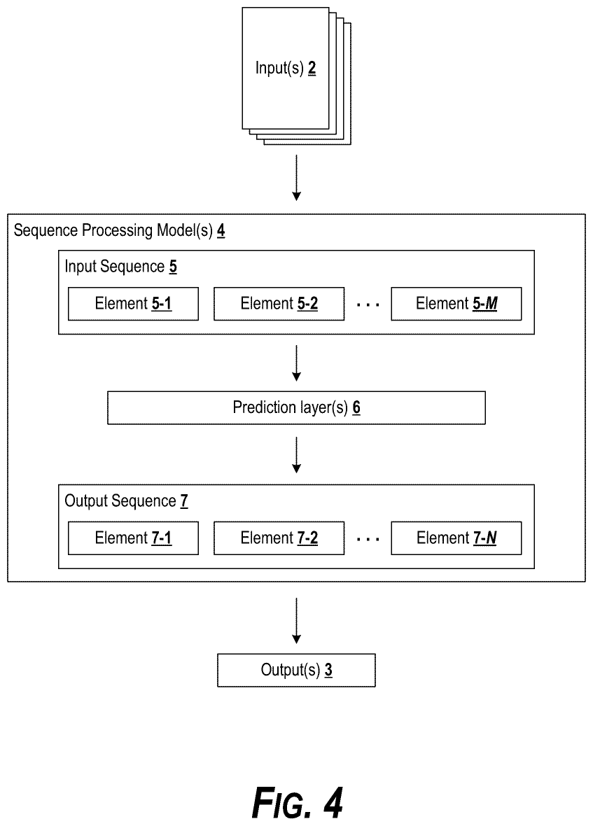

FIG. 4 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in Figure {N+1}can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

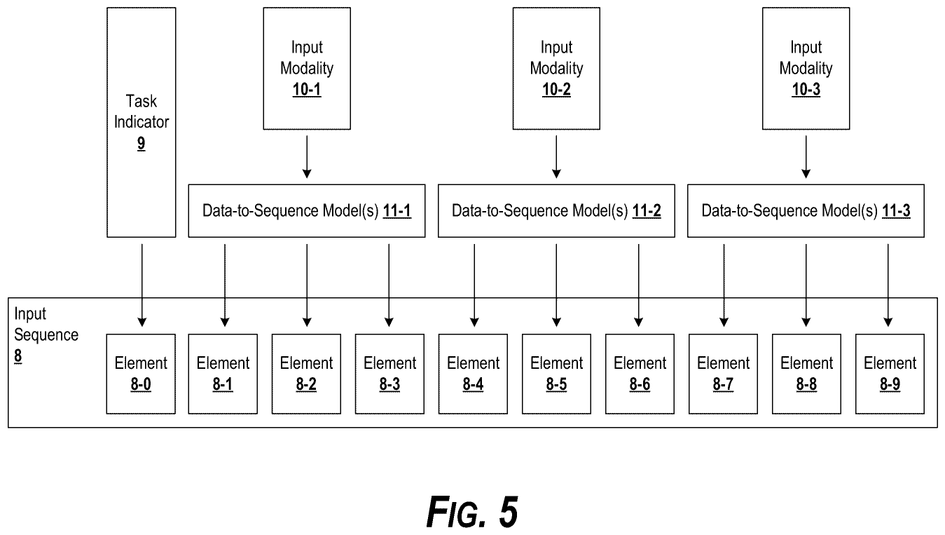

FIG. 5 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

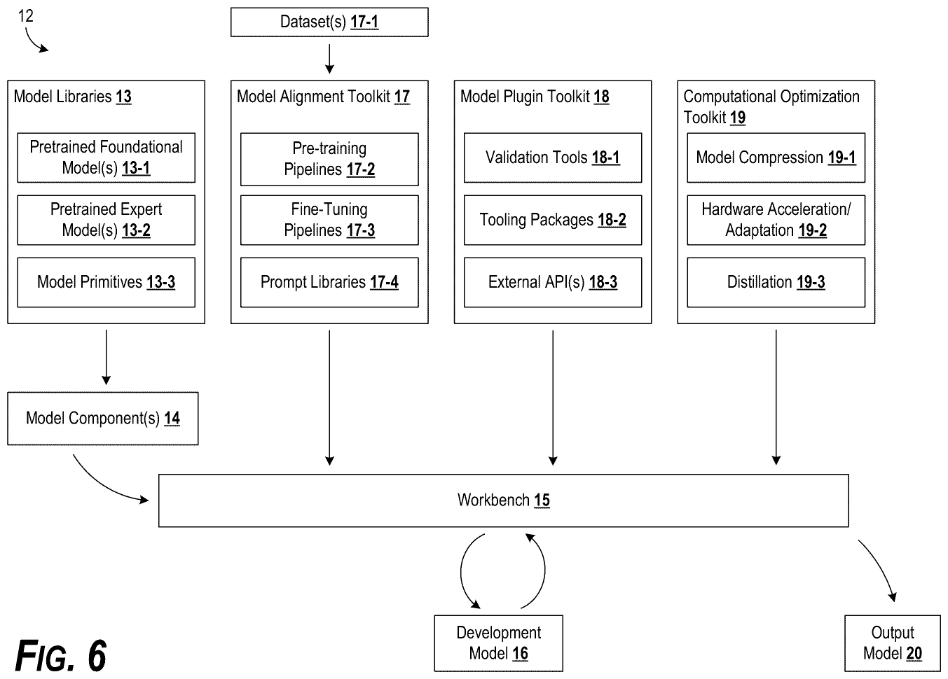

FIG. 6 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output ac input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 200 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

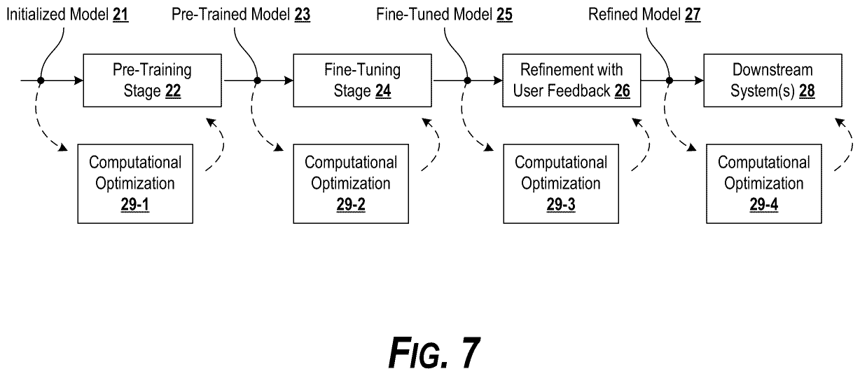

FIG. 7 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

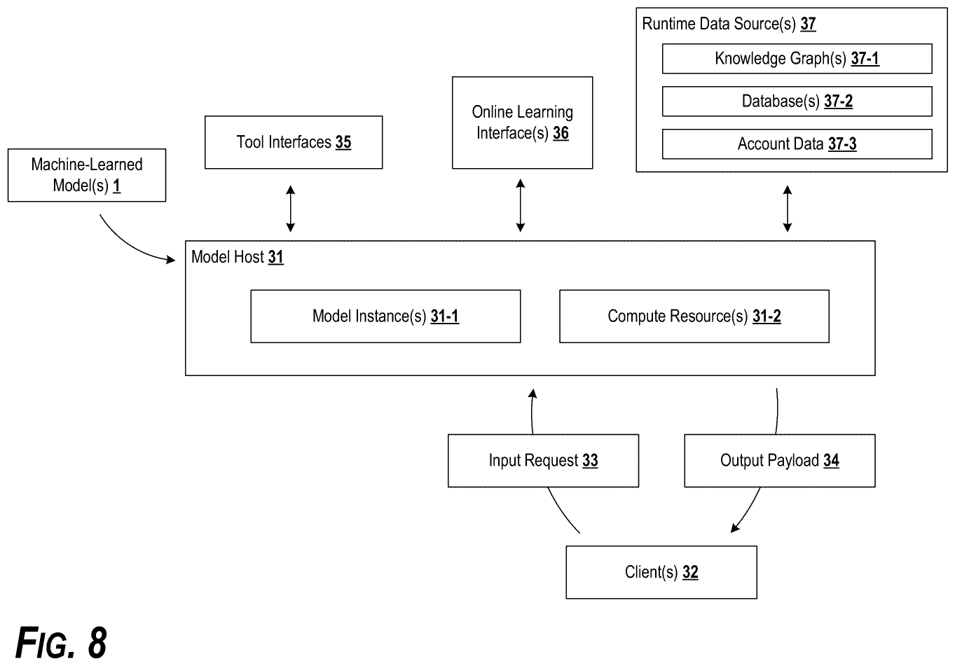

FIG. 8 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

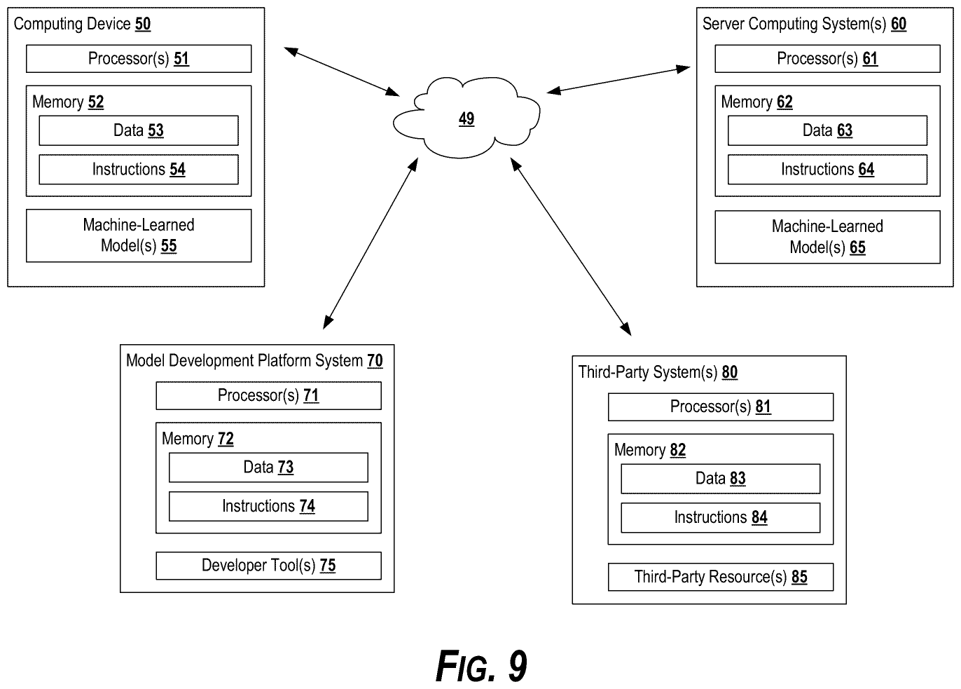

FIG. 9 depicts a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of Figure {N+6}can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

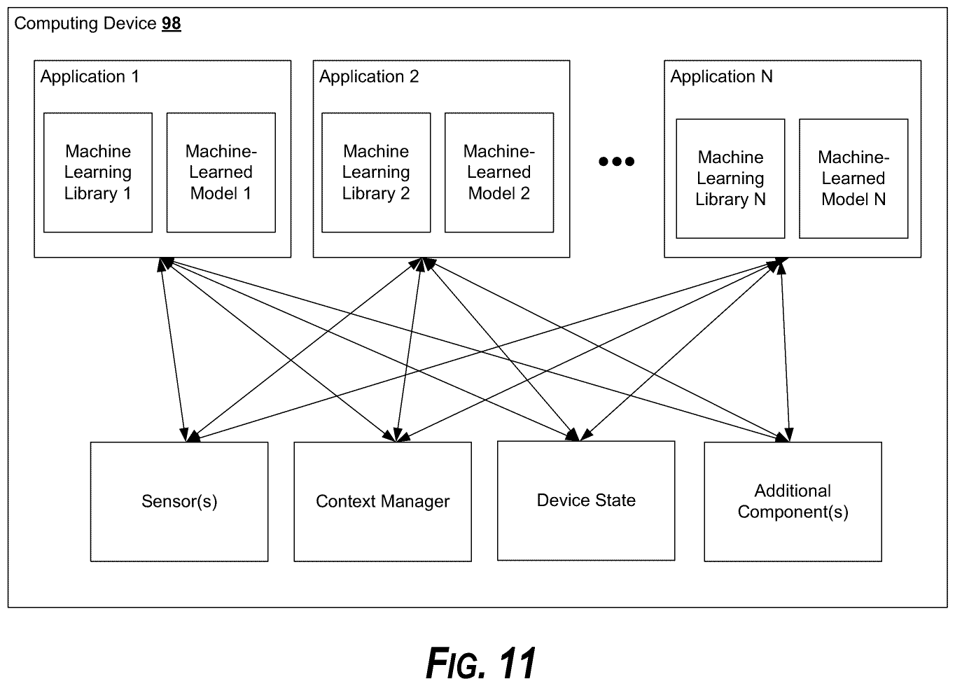

FIG. 10 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

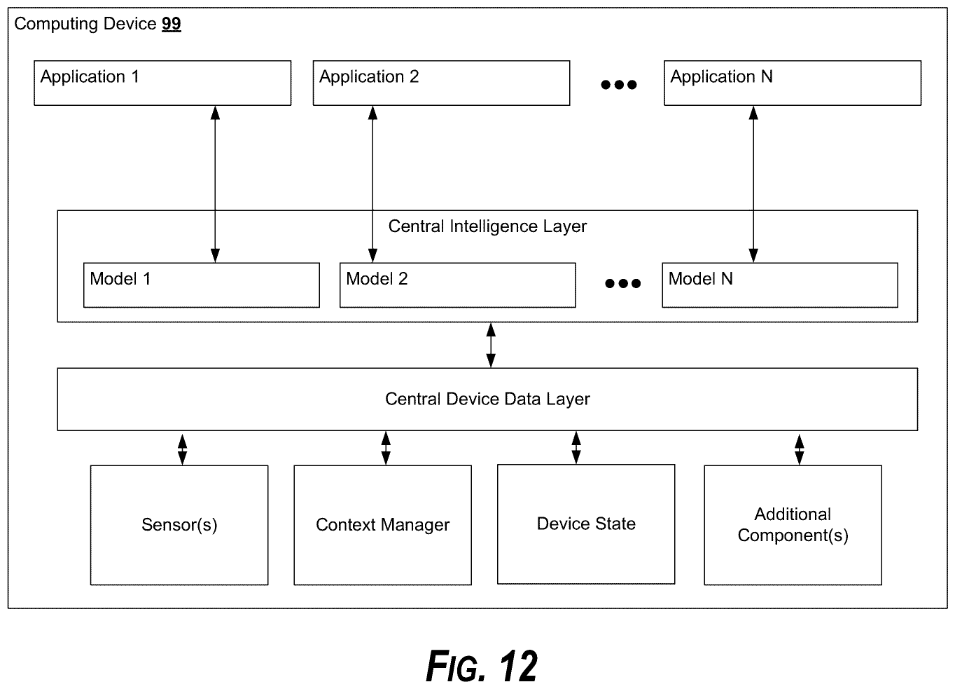

FIG. 11 depicts a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 11, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 12 depicts a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 12, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 12, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

Additional details regarding aspects of the present disclosure can be found in the attached Appendix A.

What is claimed is:

1. A system, comprising:
one or more processors; and
one or more non-transitory computer-readable media that collectively store a machine-learned model including an encoder, the encoder comprising:
a feature block configured to embed input data into a plurality of features in an embedding space, the input data including multiple components; and
one or more encoding layers, each encoding layer including a temporal attention block and a feature-wise attention block, the temporal attention block configured to obtain the embedded input data and apply temporal causal attention along a time dimension in parallel for each feature of the plurality of features to generate temporal embeddings, the feature-wise attention block configured to obtain the temporal embeddings and generate component representations of the input data, the component representations including a respective representation for each of the multiple components.

2. The system of claim 1, wherein:
the multiple components of the input data include a covariate component, a treatment component, and an outcome component; and
the component representations include a covariate representation, a treatment representation, and an outcome representation.

3. The system of claim 1, wherein:
the input data includes sequential data.

4. The system of claim 1, wherein:
the input data includes observed historical sequence data.

5. The system of claim 1, wherein:
the multiple components of the input data are time-varying components of the input data.

6. The system of claim 1, wherein the machine-learned model includes a supervised counterfactual transformer.

7. The system of claim 1, wherein the encoder comprises:
one or more pooling layers configured to obtain the component representations and generate an overall representation of the input data.

8. The system of claim 1, wherein the feature-wise attention block models interactions among different features of the plurality of features.

9. The system of claim 1, wherein:
each embedded input includes a sum of input feature projection and feature positional encoding.

10. The system of claim 1, wherein:
the temporal attention block is configured to capture temporal dependencies within each feature.

11. The system of claim 1, wherein:
the feature-wise attention block is configured to determine full self-attention along a feature dimension in a plurality of time steps.

12. The system of claim 1, wherein:
the plurality of features includes feature embeddings in an embedding space.

13. The system of claim 1, wherein:
the component representations generated by the feature-wise attention block include propagated embeddings of time-varying features.

14. A computer-implemented method to perform outcome estimation, the method comprising:
obtaining, by a computing system comprising one or more computing devices, input data including multiple components;
obtaining, by the computing system, a machine-learned model including an encoder;
providing, by the computing system, the input data as one or more inputs to the machine-learned model; and
pre-training, by the computing system, the encoder using a self-supervised learning loss having component-wise losses including a respective loss for each of the multiple components of the input data.

15. The computer-implemented of claim 14, wherein
the multiple components of the input data include a covariate component, a treatment component, and an outcome component; and
the component-wise losses include a covariate contrastive loss for a covariate representation of a covariate component of the input data, a treatment contrastive loss for a treatment representation of a treatment component of the input data, and an outcome contrastive loss for an output representation of an outcome component of the input data.

16. The computer-implemented of claim 14, wherein the machine-learned model includes a supervised counterfactual transformer.

17. The computer-implemented method of claim 14, wherein the input data includes observed historical sequence data including a plurality of sequential data points, each sequential data point including a respective covariate component, a respective treatment component, and

18. One or more non-transitory computer-readable media that collectively store a self-supervised counterfactual transformer including an encoder, the encoder comprising:
a feature block configured to embed input data into a plurality of features in an embedding space, the input data including multiple components; and
one or more encoding layers, each encoding layer including a temporal attention block and a feature-wise attention block, the temporal attention block configured to obtain the embedded input data and apply temporal causal attention along a time dimension in parallel for each feature of the plurality of features to generate temporal embeddings, the feature-wise attention block configured to obtain the temporal embeddings and generate component representations of the input data, the component representations including a covariate representation, a treatment representation, and an output representation, the component representations including a respective representation for each of the multiple components.

19. The system of claim 18, wherein:
the multiple components of the input data include a covariate component, a treatment component, and an outcome component; and
the component representations include a covariate representation, a treatment representation, and an outcome representation.

20. The system of claim 18, wherein the encoder comprises:
one or more pooling layers configured to obtain the component representations and generate an overall representation of the input data.
